(19) United States
(12) Patent Application Publication
(10) Pub. No.: US 2018/0006888 A1
(43) Pub. Date: Jan. 4, 2018

(54) ANALYTICALLY DIRECTED DATA COLLECTION IN SENSOR NETWORK

(71) Applicant: Intel Corporation, Santa Clara, CA (US)

(72) Inventors: Robert L. VAUGHN, Portland, OR (US); Sukhwinder S. CHEEMA, Santa Clara, CA (US); Mark D. SAVOY, Hillsboro, OR (US); Mariano J. PHIELIPP, Meza, AZ (US); Suraj SINDIA, Hillsboro, OR (US)

(21) Appl. No.: 15/201,377

(22) Filed: Jul. 1, 2016

(51) Int. Cl. H04L 12/24; H04L 29/08

(52) U.S. Cl. CPC H04L 41/0826; H04L 67/12; H04L 41/0813; H04L 41/32

(57) ABSTRACT

A data collection system includes a network of data nodes that are analytically directed for data collection based on data analysis. The network of data nodes are distributed over a data collection area, and collect data for the data collection area. The system includes a network manager or server that determines a data collection strategy for the data collection area based at least in part on historical data collected from the nodes. The network manager provides dynamic direction to the data nodes in accordance with the data collection strategy. The dynamic direction can cause selected one or more data nodes to dynamically change an amount of data to communicate to the network manager, such as communicating more or less data.

### FIELD

Descriptions are generally related to data collection networks, and more particular descriptions are related to dynamically configuring data collection in a data network based on analytical determination.

### COPYRIGHT NOTICE/PERMISSION

Portions of the disclosure of this patent document may contain material that is subject to copyright protection. The copyright owner has no objection to the reproduction by anyone of the patent document or the patent disclosure as it appears in the Patent and Trademark Office patent file or records, but otherwise reserves all copyright rights whatsoever. The copyright notice applies to all data as described below, and in the accompanying drawings hereto, as well as to any software described below: Copyright © 2016, Intel Corporation, All Rights Reserved.

### BACKGROUND

There is a continued increase in the deployment of sensors and data collection and data generation devices, which accompanies an increasing awareness that more and better data can provide better analytical results in any of a number of different calculation and prediction scenarios. However, deploying sensors and generating data is only one piece of the puzzle. While more data might be useful in analysis, the increase in data also requires the transmission of the data to an analysis engine, such as a data center. The transmission of data has associated real costs (e.g., infrastructure and communication network usage) as well as practical costs (e.g., how to timely deliver and process the data so that it can be useful for the purpose behind its collection).

Traditional approaches to the costs issues involve reduction of the collected data. The amount of data can be reduced by gathering less data, or by compressing the data gathered, or both. Such an approach is referred to as edge compression, referring to the fact that the edge node, or the node where the data is collected, performs the compression, rather than having all data be received at a central processing location for analysis (i.e., post collection analysis). Compression can reduce certain costs associated with gathering and transmitting data, but it comes at reduced data effectiveness as data is lost. Another traditional approach is to increase communication infrastructure to enable better distributed data collection from the data nodes. Such an approach takes significant time to build out the infrastructure, as well as significant cost.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, and/or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an embodiment of a system that provides dynamic data collection configuration for a data collection network.

FIG. 2 is a block diagram of an embodiment of a system with a manager to control the data collection of nodes of a data collection network.

FIG. 3 is a flow diagram of an embodiment of a process for dynamically changing data collection configuration of selected data nodes.

FIGS. 4A-4D are diagrammatic representations of an embodiment of data collection configuration based on analysis of a data environment.

FIG. 5A is a diagrammatic representation of a known embodiment of integrated circuit die testing.

FIG. 5B is a diagrammatic representation of exponentially increasing cost with testing further into the manufacturing process.

FIG. 5C is a diagrammatic representation of an embodiment of changing data collection further into the manufacturing process.

FIG. 5D is a diagrammatic representation of an embodiment of changing data collection further into the manufacturing process and applying neural network analysis.

FIG. 6 is a block diagram of an embodiment of a data node in which analytically directed data collection can be implemented.

FIG. 7 is a block diagram of an embodiment of a computing system for a multi-node network in which analytically directed data collection can be implemented.

FIG. 8 is a block diagram of an embodiment of a multi-node network in which analytically directed data collection can be implemented.

Descriptions of certain details and implementations follow, including a description of the figures, which may depict some or all of the embodiments described below, as well as discussing other potential embodiments or implementations of the inventive concepts presented herein.

### DETAILED DESCRIPTION

As described herein, a data collection system includes a network of data nodes distributed over a collection area and a network manager that collects the data sent from the data nodes. The network manager can analyze the data and determine a strategy for data collection in the data collection area. Thus, the network manager can analytically direct data collection for the data nodes. The network manager provides dynamic direction to the data nodes in accordance with the data collection strategy. The dynamic direction can cause selected one or more data nodes to dynamically change an amount of data to communicate to the network manager, such as communicating more or less data.

As sensor networks expand in size, for example, by increases in quantity (number of nodes), resolution (amount of data to represent a state or condition), frequency (rate at which data can be measured), or other expansion, or a combination, the costs (e.g., actual dollars or practicality or both) of collecting the data increase. By analytically determining what data to collect when, the data collection system can mitigate the cost increases without the loss of data effectiveness in large and complex data collection and sensor networks. In one embodiment, the data collection system can sample and store full fidelity data at each node, and be selective in what data to send.

It will be understood that such a system is in contrast to traditional data compression techniques. With traditional data compression, the nodes are always configured for lower fidelity data, or they collect full fidelity data and always compress it with lossy compression techniques. A data collection system as described herein can dynamically configure itself to collect the right data from the right sources at the right degree of fidelity, based on data analysis for historical data. In a sense, such a network operates similarly to a human brain that focuses attention on one thing, gathering more data from the selected item of focus, and concurrently decreases focus on other things. The brain can then shift focus as time goes or as other conditions occur. Similarly, the data collection network can dynamically adjust what nodes collect more data and what nodes collect less data, which can be changed over time based on changing conditions in an environment of the data collection area.

With traditional data compression techniques, data nodes apply compression, which results in data filtering at the edge. It will be understood that even with “smart” compression, each node performs the compression separately, which necessarily results in localized filtering and compression based on conditions only at or near the node. In contrast, the data collection system described can drive data collection from a “global” data perspective throughout the area of data collection. In one embodiment, the data collection system can apply similar compression techniques utilized in traditional systems, but will be applied based on information about the environment of the entire system or a larger portion of the system than simply the conditions localized to a specific node. Thus, the data collection system can apply data collection based on a global data perspective, referring to a system that is adaptive based on the evolving needs of the system as a whole rather than a specific node. The needs of the system can change relative to where to collect data from, frequency to collect data, granularity of data collection, data retention, or a combination, and can dynamically adjust the operation of the data nodes in accordance with the system needs.

The selective communication of data enables the use of a lower cost communication infrastructure as compared to the communication networks needed to support large and complex sensor networks gathering high fidelity data from many sensors. In one embodiment, the network manager of the system applies data collection configuration changes dynamically for data nodes that meet certain conditions. For example, for data nodes meeting certain conditions, the system can direct the data node to communicate or collect more data. In contrast, for data nodes that do not meet the conditions, the system can direct the data node to communicate or collect less data. The communication of the data can be a separate condition from the generation or sampling of the data. For example, in one embodiment, a node directed to not communicate as much data can either collect less data (and consequently have less to communicate), or hold the data in local storage, or a combination.

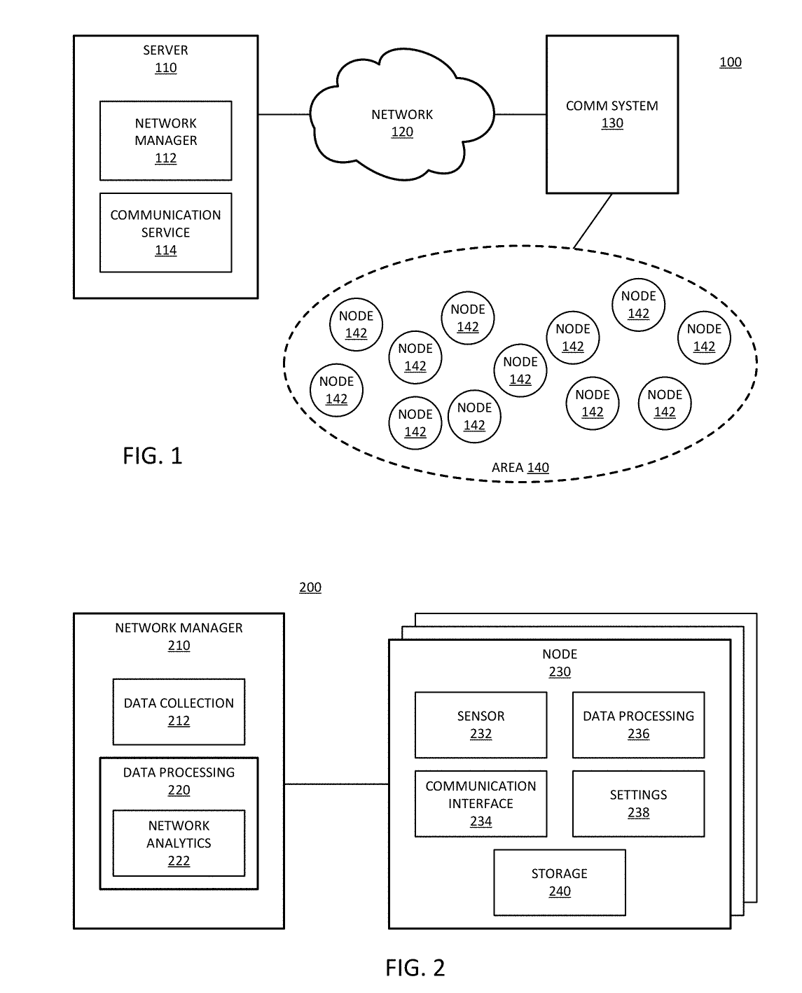

FIG. 1 is a block diagram of an embodiment of a system that provides dynamic data collection configuration for a data collection network. System 100 includes data collection area 140, with multiple nodes 142 distributed throughout the area. Area 140 can be large and complex. For example, area 140 can include dozens of nodes 142, or hundreds of nodes 142, or thousands of nodes 142. Nodes 142 can be referred to as data nodes, indicating that nodes 142 provide the data for analysis in system 100. In one embodiment, area 140 can be referred to as a sensor network. In one embodiment, area 140 can be referred to as a machine to machine (M2M) system.

In one embodiment, each node 142 is or includes a sensor. A sensor can refer to a device that measures data about an environment or a condition. A sensor can be considered to “generate” data in that a measurement or sample provides data about a condition within area 140. A sensor can be considered to collect data from the perspective that the measurements or samples are taken periodically to monitor one or more conditions. Network manager 112 of server 110 can be considered to collect the data by receiving data sent from nodes 142. Solely by way of convenience, and not by way of limitation, the operation of nodes 142 may be referred to herein as measuring, making measurements, generating data, or other expression related to the role of nodes 142 to be the source of data in system 100. Network manager 112 may be referred to herein as collecting data, based on the fact that it receives data from one or more data nodes 142.

In one embodiment, area 140 represents a geographic area. For example, meteorological sensor systems can be set up in a geographic region, or environmental sensors can be placed in a building, campus, or group of buildings, or other region. In one embodiment, area 140 represents a physical system. For example, operational sensors can be placed in an engine, a manufacturing system, a complex device, or other system. In one embodiment, area 140 represents a logic system. For example, test sensors can be applied to a test system, or monitoring sensors can be set up to track an internet-connected virtual system of distributed devices. It will be understood that these example are not limiting on the countless types or examples of systems in which a group of sensors can be employed. Where a swarm of sensors exists, one embodiment of system 100 may be applied.

While all nodes are identified as element 142, in one embodiment, nodes 142 include multiple different types of node devices. Thus, area 140 is not necessarily homogenous, but can include different types of node 142. Different node types can include different capabilities, in addition to being located at a different portion of area 140. In one embodiment, multiple sensor devices can be placed in close proximity, but with different capabilities. Thus, analysis of what nodes 142 should collect what data, and when, can include directing nodes of different types, which may be located proximate each other, to perform different types of data collection.

System 100 includes network manager 112 to manage the analytics for data nodes 142. In one embodiment, network manager 112 is implemented on server 110. Server 110 represents any type of computing system that can collect and analyze the data from data nodes 142. Server 110 can include one or more computing devices, or be all or a part of a data center, or other computing resource. Server 110 includes communication service 114, which enables server 110 to communicate over network 120. Network manager 112 can receive data from nodes 142 via communication service 114, and can provide direction to nodes 142 about how to perform data collection. Providing direction to nodes 142 can include sending one or more commands or configuration settings.

Network 120 represents network hardware and software logic resources to enable the connection of area 140 to server 110. In one embodiment, network 120 includes public network resources, such as the internet. In one embodiment, network 120 includes private network resources, such as a closed network. In one embodiment, network 120 can include private and public network infrastructure. In one embodiment, system 100 includes one or more communication systems 130 to couple area 140 to network 120 or directly to server 110, or both. Communication system 130 can represent wireless carriers, such as cellular networks, WiFi networks, or other communication resource. In one embodiment, communication system 130 or network 120 can include wired connections. In one embodiment, communication system 130 or network 120 can include wireless connections. In one embodiment, communication system 130 or network 120 can include both wired and wireless connections. It will be understood that coupling to communication system 130 can have associated data costs to enable the exchange of configuration signals from network manager 112 to nodes 142 and for data from nodes 142 to network manager 112. In one embodiment, the application of selective data collection can enable system 100 to operate as efficiently or more efficiently on a less expensive communication infrastructure as compared to a traditional system operating on a more expensive communication infrastructure.

In one embodiment, network manager 112 leverages predictive analytics to determine for nodes 142 (for example, for a network of sensors), how nodes 142 (which may be devices or sensors) should perform data collection. Thus, system 100 can collect data from nodes 142 according to frequency, geographic range, fidelity of storage (or delay of data collection), or other factors, or a combination, to improve the efficiency of data collection for area 140. Nodes 142 can adjust how and how much data to communicate to network manager 112 in accordance with the predictive analysis, for example, in response to information provided by network manager 112. Network manager 112 can communicatively couple over network 120 to provide information to nodes 142 to adjust data collection operation based on an analysis of data.

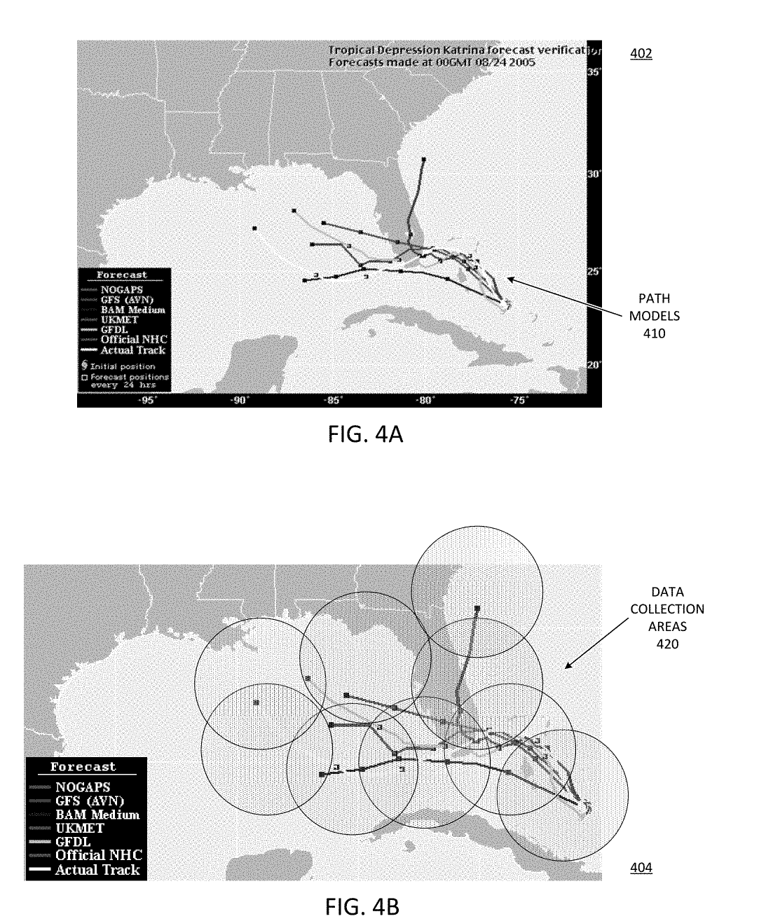

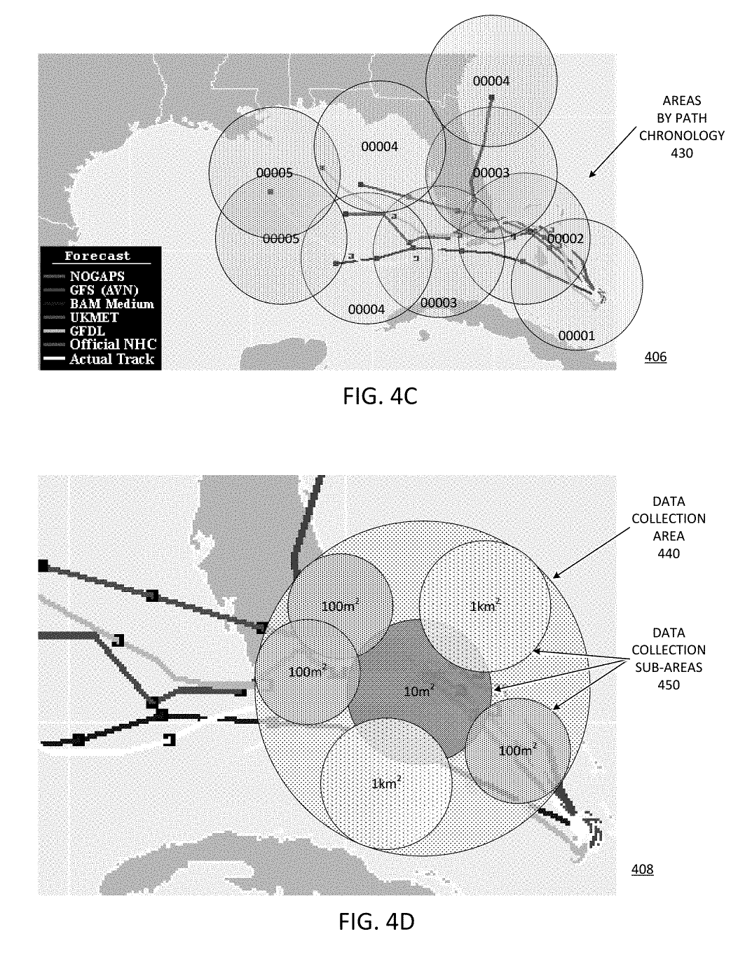

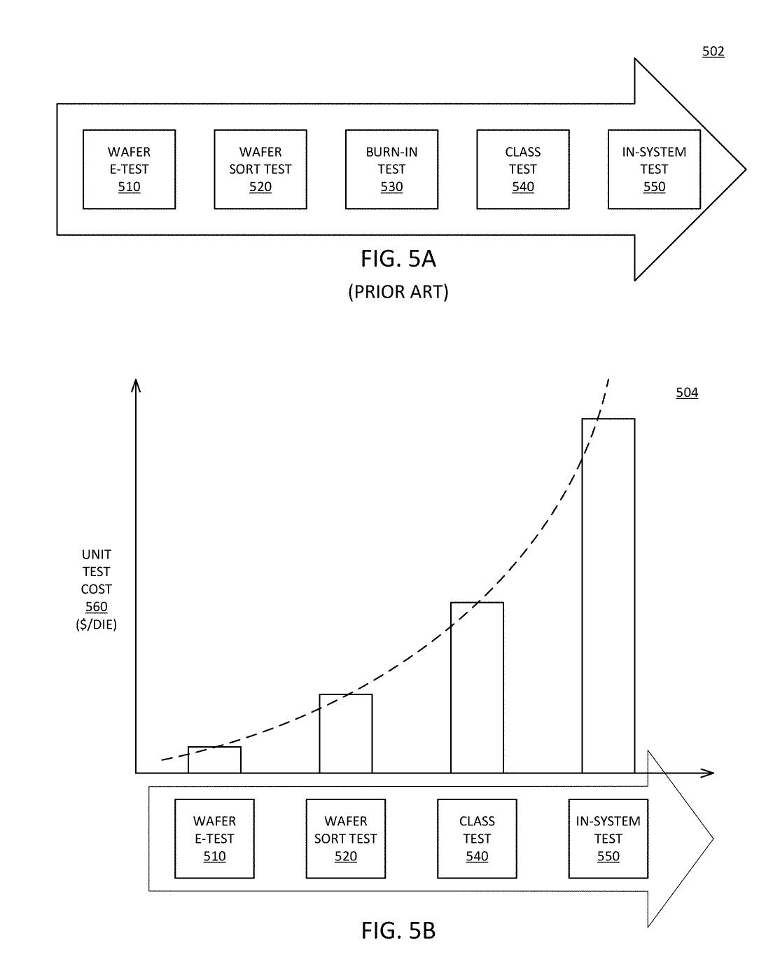

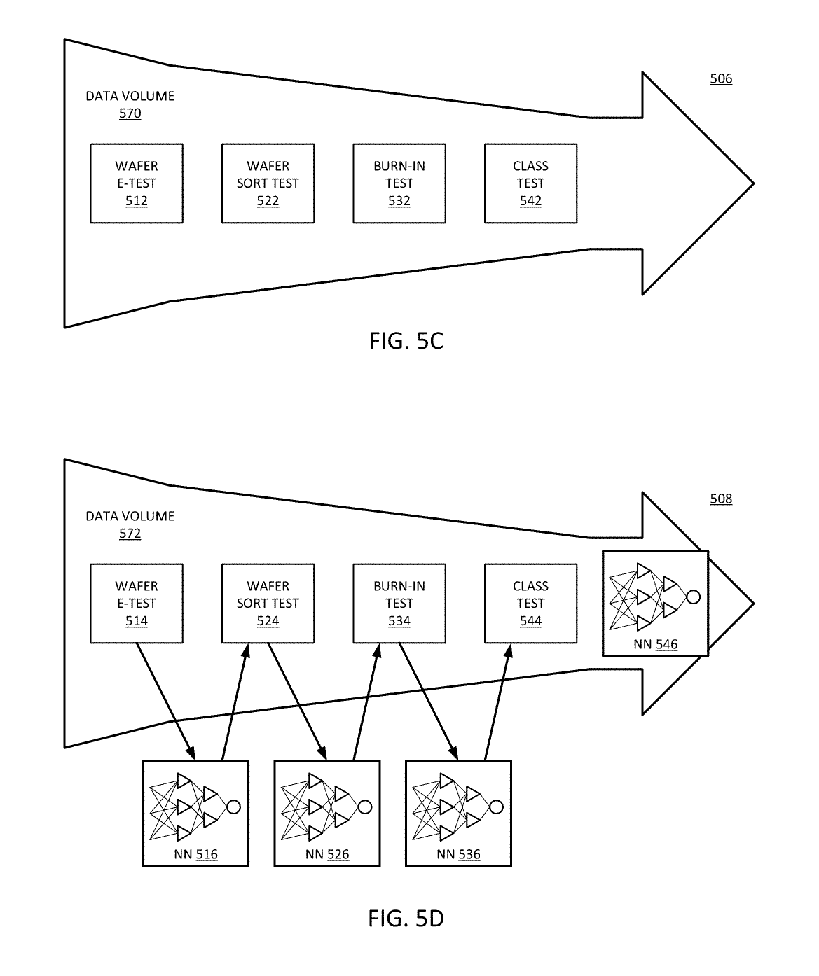

The application of data collection analytics to system 100 can enable system 100 to perform data collection in ways very different from traditional systems. For example, traditional compression systems are characterized as either lossy or lossless. With the application of data compression analytics, system 100 can be both lossy and lossless at the same time. In one embodiment, network manager 112 can direct specific nodes 142 to operate in a lossy way, while at the same time directing other nodes 142 to operate in a lossless way. Thus, system 100 as a whole can mix lossy and lossless operation for selective data collection from specific portions of area 140. In one embodiment, traditional compression techniques can be incorporated into system 100. For example, network manager 112 can direct a first node 142 to apply compression to data, while a second node 142 sends non-compressed data. Over time, the roles of the nodes may change, and the first node 142 can send non-compressed data while the second node 142 applies compression. Thus, in contrast to traditional systems that operate as either lossy or lossless, system 100 can analytically consider the relationship of timing to fidelity based on the context of what is happening within area 140. The specific examples below with respect to FIGS. 4A-4D, and FIGS. 5A-5D will provide more concrete examples.

Fundamentally, system 100 takes into account that there are costs and technical challenges to implement distributed data collection from data networks or sensor networks, and applies analytics to dynamically adjust operation within the context of limited resources to achieve high data efficiency. Applications of system 100 can include internet of things (IOT) deployments. As the number of IOT use cases continues to increase, many such systems are implemented far from terrestrial radio systems. At present, as much as 80% of the world is currently not covered by easily accessible high bandwidth telecommunication systems. Thus, the deployment of IOT systems, with every increasing data budgets experience several limitations to the effective use of their data. Currently such systems communicate through longer distance, slower wireless relays that rely on line of sight with very low data rates. Alternatively, when higher data rates are needed, line of site with microwave is possible, which requires complex (large and expensive) antennae systems. As another alternative, systems can communication via LEO (low earth orbit) satellite systems. Such satellite systems may provide higher capacity communication, but are very expensive.

FIG. 2 is a block diagram of an embodiment of a system with a manager to control the data collection of nodes of a data collection network. System 200 illustrates a simplified view of a data collection system, with network manager 210 to couple to multiple nodes 230. System 200 provides one example of a system in accordance with system 100 of FIG. 1. Nodes 230 provide one example of a node in accordance with an embodiment of node 142 of system 100. While not specifically illustrated in system 200, it will be understood that nodes 230 are distributed over a data collection area or a spatial span. The spatial span refers to an area over which the data nodes are distributed, whether a physical space or a logical space, or both. For example, certain nodes can be physically distributed, and others logically distributed as they monitor other system or environmental aspects.

In one embodiment, network manager 210 determines collectively for nodes 230 which nodes or end point devices are the most significant or offer the greatest correlation affect for a particular condition, circumstance, objective, or a combination. Network manager 210 includes data collection 212, which enables network manager 210 to receive and store data from nodes 230. In one embodiment, network manager 210 includes or accesses storage or memory resources that can store data from nodes 230.

Network manager 210 includes data processing logic 220 to perform computations on the data. In one embodiment, data processing logic 220 includes one or more software applications or processes. In one embodiment, data processing logic 220 includes an operating system or other control kernel. It will be understood that software logic executes on hardware logic resources, such as controllers or processors. Thus, data processing 220 can represent hardware logic to execute software logic. Alternatively or additionally, data processing 220 can include encoded hardware logic systems, such as programmable gate arrays or digital signal processors or a combination, to perform data processing operations.

Data processing 220 is illustrated with network analytics 222, which represents analysis logic of network manager 210. Network analytics 222 can perform data processing on data from nodes 230 to determine a data collection strategy. Network analytics 222 can perform data processing on data from nodes 230 to achieve the objective of the data gathering, such as generating a data model for the area in which nodes 230 are distributed. In one embodiment, network analytics 222 are or includes predictive analytics resources. In one embodiment, network manager 210 provides an application of one or more known predictive analytics mechanisms to determine how to direct data collection by nodes 230.

For example, in one embodiment, network analytics 222 can include data mining, which refers to one or more database applications that analyze data or groups of data for patterns. Such patterns can be computed based on relationships or relatedness of the data. Identified patterns can inform predictions of future behavior. Thus, correlation of certain data can provide an expectation of an outcome based on analysis of new data. As another example, in one embodiment, network analytics 222 can include statistical modelling, which refers to one or more mathematical models that embody a set of assumptions regarding the generation of the observed data. Thus, data processing 220 could statistically calculate a likely outcome based on input data. As another example, in one embodiment, network analytics 222 can include machine learning, which refers to the construction and study of algorithms that can learn from data and make predictions based on data. It will be understood that any combination of such examples can also be used together. There is overlap in some of the computations and some of the analytics operations, even while there are defined techniques for each, as is understood by those skilled in the art.

In one embodiment, data node 230 includes sensor 232, communication interface 234, data processing 236, configuration settings 238, and storage 240. Not every embodiment of data node 230 will include all elements. An embodiment of node 230 can include another element not specifically identified. Sensor 232 represents the data gathering capability of node 230. Sensor 232 enables node 230 to make measurements to generate data. Communication interface 234 represents hardware components to enable node 230 to interface with one or more communication networks or communication systems. Communication interface 234 can also represent logic, such as software logic, that enables the operation of the hardware interface. The software logic can include a communication stack or protocol implementation.

In one embodiment, node 230 includes data processing 236, which can represent edge compression at node 230. Edge compression refers to post collection processing on data gathered by the node. For example, some nodes 230 can include processing resources to process data, such as factoring out redundant data, applying filtering to data, compressing data, or otherwise processing the data. Such techniques will be understood to be different from directions by network manager 210 to change how data is gathered, processed, stored, or communicated, or a combination. In one embodiment, network manager 210 can direct the operation of such mechanisms within node 230. In one embodiment, network manager 210 directs configuration settings that are separate from post-collection processing, but which have an effect on what data is collected by network manager 210. In one embodiment, data processing 236 can be complementary to the analytics provided by network manager 210.

In one embodiment, settings 238 represent configuration settings related to how data is gathered by node 230, such as sample frequency, sampling rate, granularity of data sampled, or other configuration, or a combination. In one embodiment, settings 238 represent configuration settings related to how node 230 processes data with data processing 236, such as filter settings, compression settings, or other settings, or a combination. In one embodiment, settings 238 represent configuration settings related to how node 230 communicates data via communication interface 234, such as what network to use, how much data to communicate versus storing for potential later transmission, or other settings, or a combination.

Node 230 is illustrated with storage 240, which represents memory resources at the node to store data. Storage 240 can include volatile memory resources (memory resources whose state is indeterminate if power is interrupted to the memory), nonvolatile memory resources (memory resources whose state is determinate even if power is interrupted to the memory), or a combination. Storage 240 can enable node 230 to hold data for processing, to temporarily hold data (e.g., queue data) for transmission to network manager 210, to hold data for longer periods in case data is needed later, or a combination. In one embodiment, node 230 can store full fidelity data in storage 240, and initially send a lower fidelity version of the data to network manager 210. If network manager 210 later determines that the full fidelity data is desired, in one embodiment, node 230 can provide the data in response to a request by network manager 210.

In general, network analytics 222 can predict or model an expected behavior or condition in the network of nodes 230 based on computations on observed data for the network of nodes. As described herein, network manager 210 can focus the data collection by nodes 230 based on the prediction. For example, in one embodiment, in response to a prediction of a specific condition within the network of nodes 230, network analytics 222 can determine to gather more data from node sources expected to provide higher correlation to the predicted condition, and gather less data from other node sources. Thus, system 200 can be an analytic system that will choose to collect some data, to not collect some data, to collect all data, to modify a rate of sampling, to modify a range of sampling, to modify a frequency of collecting/gathering data, or other adjustment to data collection, or a combination. As such, an embodiment of system 200 can factor in the cost of local storage as compared to the cost of transmitting the data to network manager 210, and can direct nodes 230 to perform data collection consistent with which cost factor is most significant in a given circumstance. An embodiment of system 200 can direct nodes 230 to store and intelligently forward data, such as directing the nodes to sample full fidelity data, but hold the data locally instead of sending it for a period of time. If network manager 210 determines that such data is important at a later time, it can direct the nodes to forward the data for processing.

In one embodiment, network manager 210 can determine that two or more nodes are collecting substantially the same data, such as by correlating the data over an area or sub-area. Based on such a determination, network manager can direct nodes collecting redundant data to not communicate the redundant data. The node that does not communicate the redundant data can store the data for later use, or can simply drop the data. In one embodiment, network manager 210 can be considered to manage multiple nodes in aggregate as a single data node. Thus, descriptions related directing operation by a data node can refer in some embodiments to a single node, or can refer in some embodiments to multiple nodes managed in the aggregate. In one embodiment, network manager 210 can cause one or more nodes to stop communicating data (send no data), or cause nodes that were not communicating data to start communicating data.

As described, system 200 provides analytics to direct data collection devices represented by nodes 230 whether or not to transmit data, whether or not to gather data, whether to hold the data for a store and forward operation (e.g., holding certain data until a lower-cost communication resource becomes available), or what communication channel to use, or a combination. The communication infrastructure for many sensor based network systems currently leverage lower bandwidth 2G/3G wireless networks. While network bandwidth and infrastructure may eventually be upgraded to allow the use of 4G or 5G networks, system 200 can enable broader adoption of more granular sensor systems on lower bandwidth communication channels without having to discard data that “matters”, but can direct the collection of data determined to be most relevant to a particular circumstance of the network. For example, system 200 can determine which or multiple sensors to use in a given circumstance, and not collect data from one or more other sensors.

It will be understood that bandwidth throttling in network systems is known. However, such bandwidth throttling specifically degrades the experience of the data consumer by introducing packet loss or data delay or both. The data analytics of system 200 can engineer a diminished data transfer by selecting what the most important data is for a set of conditions in the network, and transmitting that data while reducing the transmission of data not determined to provide the most information for a given network condition. Thus, the diminished data is related to data collection versus traditional bandwidth throttling of live data consumption.

In one embodiment, network manager 210 can determine a cost of communication and direct node 230 to use one communication channel or another based on a cost analysis. In one embodiment, network manager 210 can cause node 230 to communicate either more data or less data, based on the circumstance within the network of nodes, an how data from that specific node correlates to the computed circumstances. Some nodes 230 can be directed to communicate more data while others are concurrently directed to communicate less data. In one embodiment, network manager 210 can cause node 230 to communicate either more data or less data based on a location or spatial region within the data collection area. In one embodiment, network manager 210 can cause node 230 to communicate either more data or less data based on sensor type or types within the node. In one embodiment, network manager 210 can dynamically adjust how node 230 performs data collection, such as adjusting how much data to collect, what frequency of sampling to use, or other factors.

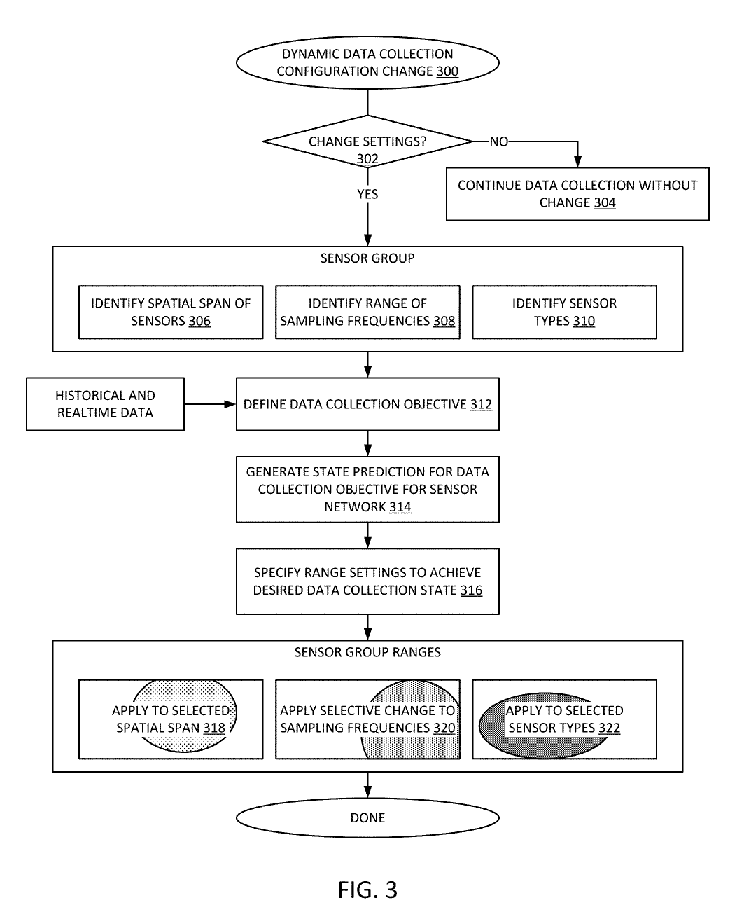

FIG. 3 is a flow diagram of an embodiment of a process for dynamically changing data collection configuration of selected data nodes. Process 300 provides one example of an embodiment for dynamically adjusting data collection configuration for an analytically directed data collection system in accordance with an embodiment of system 100 or system 200.

In one embodiment, a network manager determines whether a data collection setting change should be applied, 302. The network manager can determine a need for a change to data collection based on a change of circumstances within the data network. If there is no setting change to be made, 302 NO branch, the system can continue data collection with change, 304. If there is a need for a change of data collection settings, 302 YES branch, in one embodiment, the network manager identifies one or more aspects of the sensor group or nodes of the network.

In one embodiment, the network manager is aware of where in the network the sensors are located, and what capabilities (e.g., sensor capabilities) the sensors have. In one embodiment, in response to an initialization even or non-event operation, the data collection system can operate in accordance with preconfigured rules. The system can identify the characteristics of the sensor network including sensor type, sampling rate, location, communication cost/data rate, and other characteristics. In one embodiment, the system starts collecting data with an initial configuration, and uses data gathered to determine how to collect data going forward. If the system was previously operational, or based on a previous system, the system can have historical data and sensor network characteristics available for analysis. The system will continue to collect data based on a latest sampling plan created.

In one embodiment, in response to a need to change configuration settings, the network manager can identify a spatial span of the sensors in the network, 306. The spatial span can refer to a geographic footprint, or a range of sensing capability. In one embodiment, the network manager can identify a range of sampling frequencies for sensors, 308. A sensor may default to operation at a specific frequency, and have a range of frequencies it can use. The different frequencies will result in different amounts of data or different resolutions for data, or both. In one embodiment, the network manager can identify sensor types, 310. The sensor types can provide different sensor capabilities and provide different types of data, or different information about the same condition being monitored in the data collection area.

In one embodiment, the network manager defines a data collection objective, 312. The definition of the objective could be referred to as a definition of a problem, referring to what the data is being used to accomplish. The same data can be used differently depending on what is trying to be extracted from the sensor data. The driver for a change in data collection or a new sampling plan can be cost, granularity of data for one or more specific regions, sensor types, data retention, or other driver, or a combination. For example, to collect data about a change in situation in a specific region, in light of cost of sending data from the sensors in the particular region, a sampling strategy should account for the cost factor, the region, and the overall use of the data. The objective can be information by the use of historical data, realtime data, or a combination.

In one embodiment, the network manager leverages analytics to make predictions. The network manager can generate one or more state predictions for the data collection objective for the sensor network, 314. In one embodiment, with historical knowledge (when available), and knowledge of the sensor network characteristics (such as location, sensor type, and other characteristics), the network manager can apply analytic methods to produce a hypothesis that predicts the extension of a trend or vector. The predictive analysis can identify where additional data (e.g., more granular data, different sensor type data, or other data considerations) would help to refine the predictive hypothesis. The refinement of the predictive hypothesis can occur through iterations of computations on the data, including new data input. The result can be described as a data map or schema, and can identify what additional data would benefit the system analytics. The resulting map can identify specific data for specific regions of the data collection areas, or specific data types, or other data or a combination. Thus, the network manager can determine how to direct nodes to collect more or less data based on the analysis.

In one embodiment, the network manager can convert the predictions or the data map into a sampling plan. Again, the map or schema can be thought of as a high level abstraction. The sampling plan is the result of converting the higher level abstraction to known sensors. Thus, the network manager can specify range settings for specific sensors to achieve the desired data collection state or states identified in the predictions, 316.

Consider an example of Table 1 below. The sampling plan can specify operations by specific sensors:

TABLE 1
Sampling plan

| Record # | Date | Time | Node | Temp | Pressure | Acc-X | Acc-Y | Acc-Z |
|---|---|---|---|---|---|---|---|---|
| 1 | Nov. 17, 2015 | 6:00:00 | 103x22 | 50 | 10 | 7 | 7 | 7 |
| 2 | Nov. 17, 2015 | 6:00:00 | 103x12 | 50 | 10 | 7 | 7 | 7 |
| 3 | Nov. 17, 2015 | 6:00:00 | 103x32 | 50 | 10 | 7 | 7 | 7 |
| 4 | Nov. 18, 2015 | 6:00:00 | 103d22 | 50 | 10 | 15 | 7 | 7 |
| 5 | Nov. 19, 2015 | 6:00:00 | 107s11 | 50 | 10 | 15 | 7 | 7 |

Table 1 provides a very simple example of a sampling plan. Actual sampling plans could be significantly more complex. In Table 1, there are five different sensors identified (Nodes 103x22, 103x12, 103y32, 103d22, and 107s11) the frequency of data to collect. Record numbers 1-5 correspond, respectively, to Nodes 103x22, 103x12, 103y32, 103d22, and 107s11. In Record 1, Node 103x22 is directed to sample temperature (Temp) 50 times per time period, pressure 10 times per time period, and X, Y, and Z coordinate accelerometer data (Acc-x, Acc-y, and Acc-z, respectively) 7 times per time period. Such sampling values can be changes from what the node was previously sampling. The time period is not specified, but can be specific to the sensor type. For example, perhaps temperature is measured 50 times per hour as the temperature does not change frequently, and the accelerometer data is measured 7 times per second. In one embodiment, the network manager can provide values to indicate the sampling plan to the nodes, and thus direct or cause them to change their data collection behavior. It will be observed that the X-coordinate accelerometer for Nodes 103d22 and 107s11 are specified to be 15 times per time period as compared to 7 for the other nodes. Such a difference indicates that the analytics determined a reason to sample those sensors more frequently based on conditions in the sensor network.

After generating a sampling plan, the network manager can provide the direction to the sensors. In one embodiment, the network manager only provides sampling information to a node that should change its data collection behavior; nodes that are not affected may not be notified, and allowed to continue in accordance with previous operation. In one embodiment, the network manager implements the sampling plan only in subsets. The shaded areas in the sensor group ranges represent the subset implementation. Thus, implementation may be by only specific nodes that meet certain conditions, and is not implemented by all nodes. Again, as an example, certain nodes may be left to continue operation as they previously operated, and nodes that need to make an adjustment to collect more or less data are included in the implementation. Such changes can be because a node includes certain sensor characteristics affected by the sampling plan.

In one embodiment, the network manager directs one or more sensors to make a change to data collection based on a spatial span of the sensors, 318. Thus, the sensors can be changed based on where they are in the network. In one embodiment, the network manager directs the selective application of a change to sampling frequencies of one or more sensors, 320. In one embodiment, the network manager directs the selective application of a change based on sensor type, 322.

FIGS. 4A-4D are diagrammatic representations of an embodiment of data collection configuration based on analysis of a data environment. Referring to FIG. 4A, diagram 402 provides a representation of a storm path prediction. Diagram 402 provides a meteorological data collection case study example. Path models 410 represent predictive models of potential paths for Hurricane Katrina, which struck the southern coast of the United States in 2005. Since the storm has occurred, data is available to indicate exactly what path the storm took. However, for purposes of the example, the predicted paths provide the interest in the case study to illustrate how an analytically driven data collection system can work.

It will be observed that path models 410 illustrate potential paths for the hurricane anywhere from turning north and crossing over Florida in one extreme example, to continuing to head west toward Mexico in another example. Other models more closely predicted what actually happened. But from the perspective of forecasting, it is unclear what will happen.

Referring to FIG. 4B, meteorologists have distributed hundreds of thousands of sensor devices around the Gulf of Mexico. For purposes of simplicity, diagram 404 illustrates a small subset of data collection areas 420, which can be considered sub-areas of a meta-data collection area represented by all of data collection areas 420. Diagram 404 illustrates data collection areas 420 overlaid on the path models from diagram 402. The sensor devices start transmitting data after deployment, and a computer system can process the data to extrapolate an observed trend to produce forecasts of possible storm paths.

In the specific condition of the storm, the objective of the data will be to inform the prediction of hurricane route modeling. It stands to reason that the hurricane path modeling will be better informed by collecting data from locations that are relative to or correlated with the predicted storm path and impact area(s). Thus, the system can use path models 410 as a guide to where data should be collected from data collection areas 420. With such information, the system can better forecast weather forces as well as forecasting damage.

In one embodiment, the system performs predictive analysis to orchestrate the identification and collection of sensor data from specific sensors or sensor networks that best fit with the predictive models. Thus, the system can identify specific data collection areas 420 that are calculated to be most likely to be in the hurricane's path in accordance with path models 410. Consider a first scenario involving storm path prediction. Suppose there are sensors in data collection areas 420 that have the capabilities to measure environmental data such as wind speed, altitude, barometer, and temperature. Other data points could also or alternatively be considered. Wind speed data and temperature are obviously different data, and can have correlations that inform the system about hurricane path, especially when correlated with barometer readings and altitude measurements. With certain temperature and wind speed data, the system may need more detailed information about barometer readings to improve a particular path prediction. In one embodiment, the network manager known the sensor capabilities, and can calculate what barometric information would help the particular path prediction. In one embodiment, the network manager can direct the data collection of sensors to provide that information.

Referring to FIG. 4C, diagram 406 illustrates data collection areas 420 overlaid over path models 410, and the circles representing the collection areas include number to represent a chronology of data collection, or an organization of the areas by path chronology 430. Chronology 430 illustrates the start of the hurricane to the southeast at 00001, moving northwest at 00002. At the point in time where 00001 is the starting point of the current condition, there is a divergence in predicted paths. The predicted paths will move through one of the areas identified as 00003, although it is unclear which path will actually occur. The models predict movement into areas chronologically identified as 00004, and then 00005. It will be understood that other designations can be used.

With chronology 430, the system can identify a chronology of data collection for specific areas. Thus, the system can determine when sensors will collect data. The system can provide an adaptive schedule to establish when sensors in specific areas or sub-areas should start collecting and sending data. In accordance with the knowledge of sensor capabilities and what data is needed to make better predictions, the system can also determine which sensor data should be focused on, and which sensors or nodes to use. Thus, the change in conditions in the data collection area can change how the system performs data collection, or the system can adjust data collection behavior in response to changes in conditions in the data collection area or environment.

Referring to FIG. 4D, diagram 408 illustrates a close-up of the area identified in diagram 406 as having a chronology of 00002, which is identified in diagram 408 as data collection area 440. In one embodiment, the system further subdivides area 440 in accordance with what is predicted to happen in area 440 as a whole. For example, consider a scenario where the system is trying to determine how many of the network of sensors should be activated to collect data. With a high enough density of sensors, there will be many sensors whose data would be redundant given the low likelihood that the storm path will traverse the regions monitored by those particular sensors.

Data collection area 440 is illustrated with selected sub-area divisions 450 being identified. Sub-areas 450 can provide improved granularity of data collection for the system. In one embodiment, the system can compute granularity of data collection to determine how many sensors within a given area should collect data. Diagram 408 illustrates as one example, granularities of 10 m² in the center sub-area, 100 m² in the sub-areas most likely to be in the storm's path, and 1 km² in areas unlikely to be in the storm's path. Thus, the network manager can direct more nodes in specific sub-regions to collect data than in other regions. The network manager can be considered to configure a data node to collect more or less data or a sensor network or sub-network to collect more or less data, for example, by how many sensors are activated, or how much data is gathered for the sub-region.

In one embodiment, path models 410 represent a set of vectors, and predictive analytics can provide the set vectors from which sensors will be orchestrated for data collection. Each vector can be considered a plot line, from which points can be identified along the length of the plot. In one embodiment, the quantity of points can be based on a balance of the total available sensor collection points against granularity and sampling requirements. For each data collection point identified, the system can compute a radius based on the range or extent of influencing data predicted for the vector. In one embodiment, the system can compute a data collection schedule to identify data collection behavior for each region or each data node, or each sensor, or a combination. It will be understood that by establishing a schedule and allowing sensors in regions of lower likelihood to gather and store data, in the case of error checking and correction, for a node considered initially to not be needed, the network manager can request data from the node. Thus, the system can be very adaptive to changing conditions in the measurement areas.

The example of FIGS. 4A-4D focused on ocean based data collection for a storm monitoring system. The same or similar principles can be applied by system in countless other example use cases, such as agricultural monitoring systems, pipeline management, environmental sensing, or others. Consider another example of a large industrial scale farm with a sensor network distributed over a large parcel of land, which can monitor soil moisture. Such a system can utilize the data to manage irrigation and watering. Currently, such data is likely be collected via terrestrial based wireless methods, which requires expensive infrastructure to be put in place. For a farm in a developing country, such a communication infrastructure cost may be prohibitive even if such an infrastructure was possible in a developed nation.

An analytics based data collection system can reduce the cost of data collection by analytically focusing data collection, as opposed to traditional options of reducing sampling frequency, increasing lossy edge compression, increasing filtering on the edge, or completely turning sampling off in some areas by mere guesswork. The data collection system can collect the right data at the right times, while working within the confines of limited communication bandwidth. The system can make predictions based on historical trends and other data points, and direct which sensors (e.g., IOT devices) would most likely collect the most meaningful data.

In addition to water consumption, in the agriculture/farming realm such a system could provide distributed intelligence for use in fertilizer/pesticide monitoring and distribution, yield analysis, or other data applications. In energy production and distribution, such a system can provide a large distributed sensor system to better predict failures in pipelines, or in valve and compressor systems. In manufacturing environments, such a system can provide a large distributed sensor system for predictive failure analysis, quality analysis, or other manufacturing analysis. In addition, other large distributed sensor systems can utilize such data collection analytics, such as for street or highway traffic analysis, air traffic systems for drones or aircraft, factory systems, or other systems.

Whether a data collection system has the intent to collect data across the vastness of the oceans or within semi-conductor manufacturing, the number of data collection points are generally increasing in today's systems. With the increase of data collection points comes challenges with effectively collecting the information. The analytics-based data collection systems allow for the right data to be collected at the right time at the right level of granularity.

FIG. 5A is a diagrammatic representation of a known embodiment of integrated circuit die testing. Diagram 502 provides a representation of integrated circuit test data collection. The testing is considered to flow in the direction of the arrow. As illustrated, a test system can collect data at every stage in the manufacturing flow. Data collection at every stage of the manufacturing flow costs money. In a traditional system, the testing may perform wafer-based electronic test 510 after completion of the semiconductor processing. The testing may perform wafer sort test 520 to sort dies based on their performance. The testing may perform burn-in test 530 to stress test the devices and class test 540 to provide a final device rating. The testing traditionally performs in-system test 550 to test the device in a test platform to see whether the device operates in a test platform. Each die may proceed through multiple test stages in accordance with diagram 502 prior to being shipped to a customer.

FIG. 5B is a diagrammatic representation of exponentially increasing cost with testing further into the manufacturing process. Diagram 504 illustrates one example of relative costs for testing. While actual numbers and values vary, the cost increase as the stages of the testing progress can be exponential. Whether or not the curve is exponential, the cost of test progressively increases, and each stage of testing and data collection is higher compared to the previous stage. Diagram 504 plots one example of a scaled relative cost as unit test cost 560, which can be measured as a dollar amount per die.

FIG. 5C is a diagrammatic representation of an embodiment of changing data collection further into the manufacturing process. Diagram 506 illustrates one example of die testing based on data analysis. More specifically, the test system can apply data analytics to test data to compute inter-die and intra-die correlation to minimize data collection and predict future performance with less data. In diagram 506, it will be observed that the arrow representing the flow of the manufacturing process starts out larger, and narrows towards the end of the testing. The narrowing represents the decreasing of data volume 570 as the testing process progresses toward a final pass/fail decision for the die.

The testing process is illustrated with wafer electronic test 512, wafer sort test 522, burn-in test 532, and class test 542. These tests can be the same or similar to wafer electronic test 510, wafer sort test 520, burn-in test 530, and class test 540, respectively, of diagram 502. Thus, these tests can be the same or similar to known tests. However, in contrast to traditional testing, in one embodiment, the test system includes data analytics to provide an analytically directed method to collect data at each test stage, only to the extent necessary to make the final pass/fail decision of the die. It will be observed that diagram 506 lacks a counterpart in-system test or system level test (SLT), which is the most expensive test. The data analytics can provide directed data collection operation in the testing system, which can reduce the amount of testing needed at each subsequent stage of testing, and significantly reduce testing costs. The volume of data the system collects is higher at the early stages of the test flow while it is progressively lower as the die proceeds forward in each manufacturing step.

FIG. 5D is a diagrammatic representation of an embodiment of changing data collection further into the manufacturing process and applying neural network analysis. Diagram 508 illustrates a testing flow in accordance with the flow of diagram 506. The process flow arrow illustrates the decreasing data volume 572 of data collected during testing.

The testing process is illustrated with wafer electronic test 514, wafer sort test 524, burn-in test 534, and class test 544. These tests can be the same or similar to wafer electronic test 510, wafer sort test 520, burn-in test 530, and class test 540, respectively, of diagram 502, or wafer electronic test 512, wafer sort test 522, burn-in test 532, and class test 542, respectively, of diagram 506, or both.

Diagram 508 specifically illustrates the application of one or more neural network (NN) analyses in the testing process. The neural networks represent neural network implementations in accordance with any known neural network or other machine learning classifier. Neural network 516 represents machine learning analysis after wafer electronic test 514. Neural network 526 represents machine learning analysis after wafer sort test 524. Neural network 536 represents machine learning analysis after burn-in test 534. Neural network 546 represents machine learning analysis after class test 544, and can be used as a substitute for in-system testing of the die. The output of neural network 546 can provide a pass/fail status based on a testing status of the die at each stage. It will be understood that as with the testing flow of diagram 506, the amount of data needed to be collected can decrease at each subsequent testing stage.

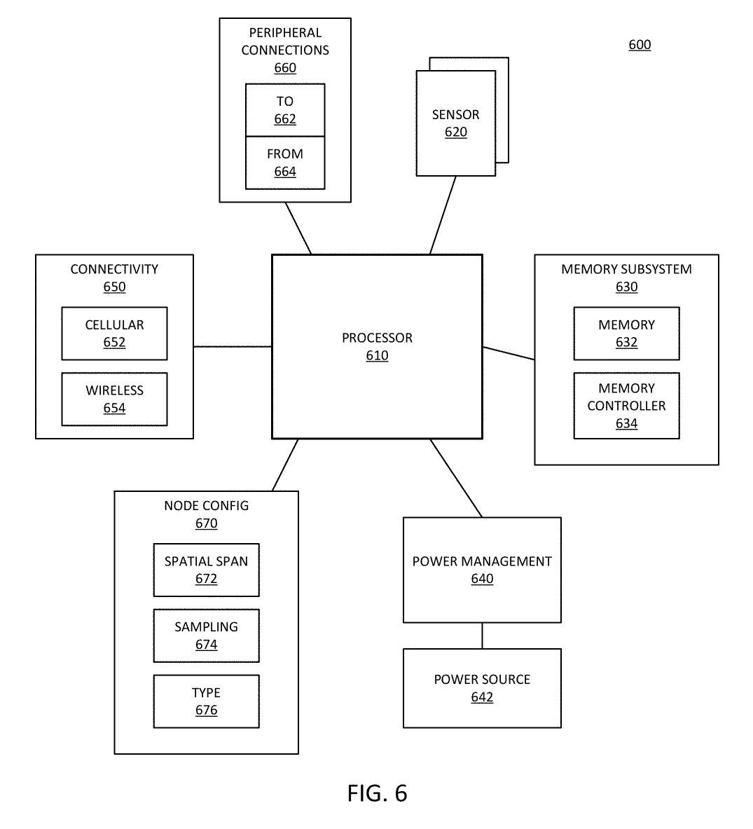

FIG. 6 is a block diagram of an embodiment of a data node in which analytically directed data collection can be implemented. In one embodiment, device 600 represents a mote, internet of things (IOT) device, or other sensor device. Device 600 provides one example of a device that is or that enables a data node for any embodiment of a data collection system described herein. It will be understood that certain of the components are shown generally, and not all components of such a device are shown in device 600.

Device 600 includes processor 610, which performs the primary processing operations of device 600. Processor 610 can include one or more physical devices, such as microprocessors, application processors, microcontrollers, programmable logic devices, or other processing means. The processing operations performed by processor 610 include the execution of an operating platform or operating system on which applications and device functions are executed. The processing operations include operations related to I/O (input/output) with a human user or with other devices, operations related to power management, operations related to connecting device 600 to another device, or a combination. Processor 610 can execute data stored in memory. Processor 610 can write or edit data stored in memory.

In one embodiment, system 600 includes one or more sensors 620. Sensors 620 represent embedded sensors or interfaces to external sensors, or a combination. Sensors 620 enable system 600 to monitor or detect one or more conditions of an environment or a device in which system 600 is implemented. Sensors 620 can include environmental sensors (such as temperature sensors, motion detectors, light detectors, cameras, chemical sensors (e.g., carbon monoxide, carbon dioxide, or other chemical sensors)), pressure sensors, accelerometers, gyroscopes, medical or physiology sensors (e.g., biosensors, heart rate monitors, or other sensors to detect physiological attributes), global positioning system (GPS), or other sensors, or a combination. Sensors 620 can also include sensors for biometric systems such as fingerprint recognition systems, face detection or recognition systems, or other systems that detect or recognize user features. Sensors 620 should be understood broadly, and not limiting on the many different types of sensors that could be implemented with system 600. In one embodiment, one or more sensors 620 couples to processor 610 via a frontend circuit integrated with processor 610. In one embodiment, one or more sensors 620 couples to processor 610 via another component of system 600.

Memory subsystem 630 includes memory device(s) 632 for storing information in device 600. Memory subsystem 630 can include nonvolatile (state does not change if power to the memory device is interrupted) or volatile (state is indeterminate if power to the memory device is interrupted) memory devices, or a combination. Memory 630 can store application data, user data, music, photos, documents, or other data, as well as system data (whether long-term or temporary) related to the execution of the applications and functions of system 600. In one embodiment, memory subsystem 630 includes memory controller 634 (which could also be considered part of the control of system 600, and could potentially be considered part of processor 610). Memory controller 634 includes a scheduler to generate and issue commands to memory device 632.

In one embodiment, device 600 includes power management 640 that manages battery power usage, charging of the battery, and features related to power saving operation. Power management 640 manages power from power source 642, which provides power to the components of system 600. In one embodiment, power source 642 includes an AC to DC (alternating current to direct current) adapter to plug into a wall outlet. Such AC power can be renewable energy (e.g., solar power, motion based power). In one embodiment, power source 642 includes only DC power, which can be provided by a DC power source, such as an external AC to DC converter. In one embodiment, power source 642 includes wireless charging hardware to charge via proximity to a charging field. In one embodiment, power source 642 can include an internal battery or fuel cell source.

Connectivity 650 includes hardware devices (e.g., wireless or wired connectors and communication hardware, or a combination of wired and wireless hardware) and software components (e.g., drivers, protocol stacks) to enable device 600 to communicate with external devices. The external device could be separate devices, such as other computing devices, wireless access points or base stations, as well as peripherals such as headsets, printers, or other devices. In one embodiment, system 600 exchanges data with an external device for storage in memory or for display on a display device. The exchanged data can include data to be stored in memory, or data already stored in memory, to read, write, or edit data.

Connectivity 650 can include multiple different types of connectivity. To generalize, device 600 is illustrated with cellular connectivity 652 and wireless connectivity 654. Cellular connectivity 652 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), lower speed networks such as 2G or 3G, or other cellular service standards. Wireless connectivity 654 refers to wireless connectivity that is not cellular, and can include personal area networks (such as Bluetooth), local area networks (such as WiFi), or wide area networks (such as WiMax), or other wireless communication, or a combination. Wireless communication refers to transfer of data through the use of modulated electromagnetic radiation through a non-solid medium. Wired communication occurs through a solid communication medium.

Peripheral connections 660 include hardware interfaces and connectors, as well as software components (e.g., drivers, protocol stacks) to make peripheral connections. It will be understood that device 600 could both be a peripheral device (“to” 662) to other computing devices, as well as have peripheral devices (“from” 664) connected to it. Device 600 commonly has a “docking” connector to connect to other computing devices for purposes such as managing (e.g., downloading, uploading, changing, synchronizing) content on device 600. Additionally, a docking connector can allow device 600 to connect to certain peripherals that allow device 600 to control content output, for example, to audiovisual or other systems.

In addition to a proprietary docking connector or other proprietary connection hardware, device 600 can make peripheral connections 680 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other type.

In one embodiment, device 600 includes node configuration 670. Node configuration can include configuration that controls the collection of data by device 600. In one embodiment, spatial span 672 refers to a sensing range for device 600. In one embodiment, sampling 674 refers to a sampling rate or sampling frequency of one or more sensors 620. Type 676 can refer to the types of sensor 620 included in device 600. Device 600 collects data and provides it to a network manager of a data center or other processing center. The network manager can direct device 600 to change sampling 674 based on data analytics. Device 600 may be selective enabled or disabled for data collection and how to collect data based on spatial span 672 or sensor type 676 or both.

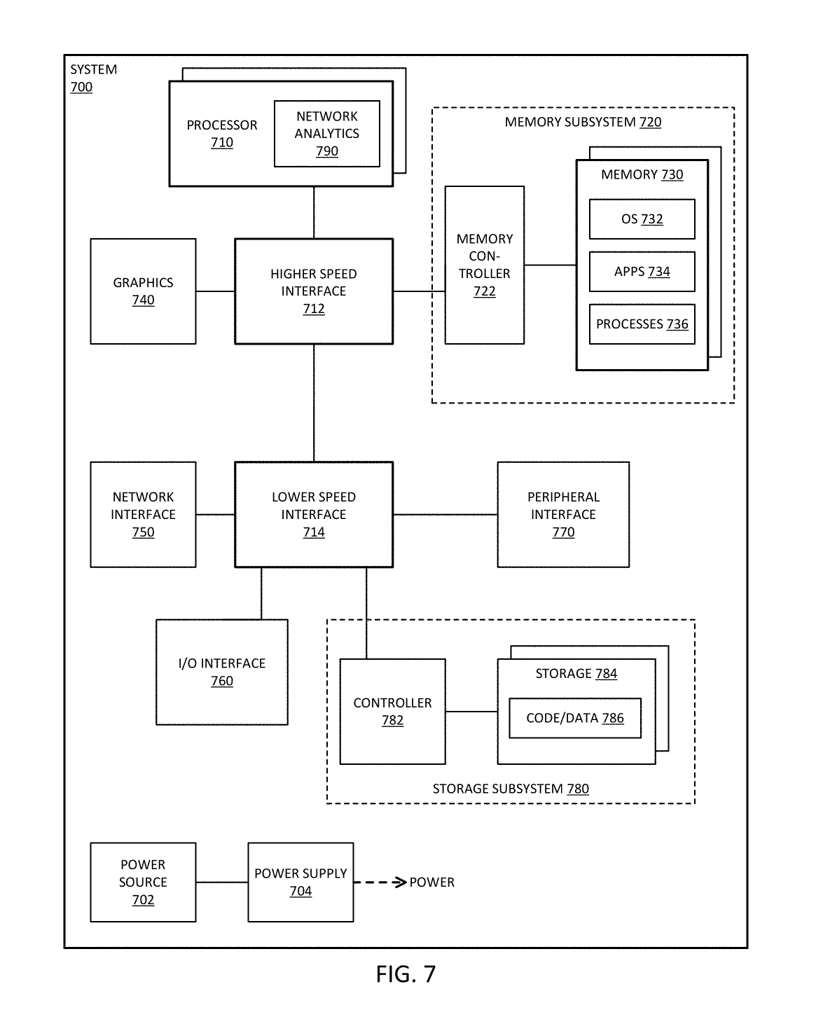

FIG. 7 is a block diagram of an embodiment of a computing system for a multi-node network in which analytically directed data collection can be implemented. System 700 represents a server or computing device to execute an analytics system in accordance with any embodiment described herein. System 700 can represent a blade server, or a computation node of a blade (in an implementation where a blade includes multiple nodes), or a storage server, or other computational node. System 700 includes memory resources as described in more detail below.

System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one embodiment, system 700 includes interface 712 coupled to processor 710, which can represent a higher speed interface or a high throughput interface for system components that needs higher bandwidth connections, such as memory subsystem 720 or graphics interface components 740. Interface 712 can represent a “north bridge” circuit, which can be a standalone component or integrated onto a processor die. Graphics interface 740 interfaces to graphics components for providing a visual display to a user of system 700. In one embodiment, graphics interface 740 generates a display based on data stored in memory 730 or based on operations executed by processor 710 or both.

Memory subsystem 720 represents the main memory of system 700, and provides storage for code to be executed by processor 710, or data values to be used in executing a routine. Memory subsystem 720 can include one or more memory devices 730 such as read-only memory (ROM), flash memory, one or more varieties of random access memory (RAM), or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide logic to provide functions for system 700. In one embodiment, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (commonly referred to as “Firewire”).

In one embodiment, system 700 includes interface 714, which can be coupled to interface 712. Interface 714 can be a lower speed interface than interface 712. In one embodiment, interface 714 can be a “south bridge” circuit, which can include standalone components and integrated circuitry. In one embodiment, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, USB (universal serial bus), or other wired or wireless standards-based or proprietary interfaces. Network interface 750 can exchange data with a remote device, which can include sending data stored in memory or receiving data to be stored in memory.

In one embodiment, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one embodiment, system 700 includes storage subsystem 780 to store data in a nonvolatile manner. In one embodiment, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (i.e., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (i.e., the value or state of the data is indeterminate if power is interrupted to system 700). In one embodiment, storage subsystem 780 includes controller 782 to interface with storage 784. In one embodiment controller 782 is a physical part of interface 714 or processor 710, or can include circuits or logic in both processor 710 and interface 714.

Power source 702 provides power to the components of system 700. More specifically, power source 702 typically interfaces to one or multiple power supplies 704 in system 702 to provide power to the components of system 700. In one embodiment, power supply 704 includes an AC to DC (alternating current to direct current) adapter to plug into a wall outlet. Such AC power can be renewable energy (e.g., solar power) power source 702. In one embodiment, power source 702 includes a DC power source, such as an external AC to DC converter. In one embodiment, power source 702 or power supply 704 includes wireless charging hardware to charge via proximity to a charging field. In one embodiment, power source 702 can include an internal battery or fuel cell source.

In one embodiment, system 700 includes network analytics 790, which can be or include a network manager to execute an analytics directed data collection system in accordance with any embodiment described herein. Network analytics 790 can determine what data to collect, and when, and at what level of granularity. Network analytics 790 provides direction to a network of data nodes to dynamically adjust data collection operation in accordance with data analytics, in accordance with any embodiment described herein. System 700 can be a server or server system that can provide data analytics or machine learning or both to manage the data collection behavior of a sensor network.

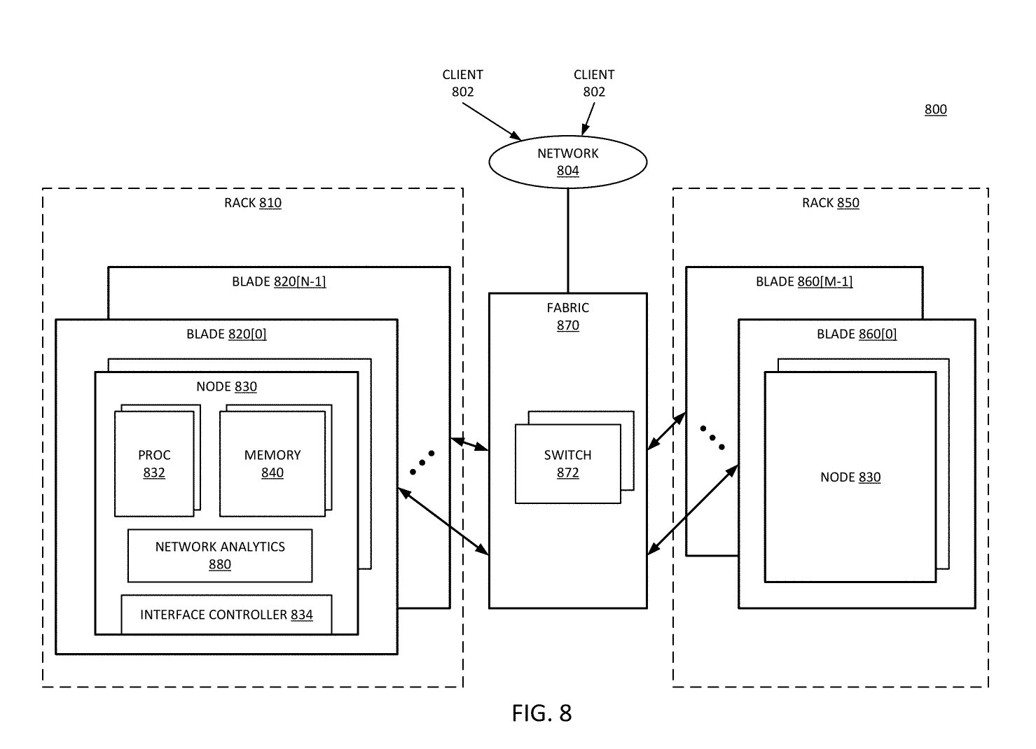

FIG. 8 is a block diagram of an embodiment of a multi-node network in which analytically directed data collection can be implemented. System 800 represents a data center or cloud server for an analytics system in accordance with any embodiment described herein. In one embodiment, system 800 represents a data center. In one embodiment, system 800 represents a server farm. In one embodiment, system 800 represents a data cloud or a processing cloud. System 800 can include one or more computing devices in accordance with system 700.

One or more clients 802 make requests over network 804 to system 800. Network 804 represents one or more local networks, or wide area networks, or a combination. Clients 802 can be human or machine clients, which generate requests for the execution of operations by system 800. System 800 executes applications or data computation tasks requested by clients 802.

In one embodiment, system 800 includes one or more racks, which represent structural and interconnect resources to house and interconnect multiple computation nodes. In one embodiment, rack 810 includes multiple nodes 830. In one embodiment, rack 810 hosts multiple blade components 820. Hosting refers to providing power, structural or mechanical support, and interconnection. Blades 820 can refer to computing resources on printed circuit boards (PCBs), where a PCB houses the hardware components for one or more nodes 830. In one embodiment, blades 820 do not include a chassis or housing or other “box” other than that provided by rack 810. In one embodiment, blades 820 include housing with exposed connector to connect into rack 810. In one embodiment, system 800 does not include rack 810, and each blade 820 includes a chassis or housing that can stack or otherwise reside in close proximity to other blades and allow interconnection of nodes 830.

System 800 includes fabric 870, which represents one or more interconnectors for nodes 830. In one embodiment, fabric 870 includes multiple switches 872 or routers or other hardware to route signals among nodes 830. Additionally, fabric 870 can couple system 800 to network 804 for access by clients 802. In addition to routing equipment, fabric 870 can be considered to include the cables or ports or other hardware equipment to couples nodes 830 together. In one embodiment, fabric 870 has one or more associated protocols to manage the routing of signals through system 800. In one embodiment, the protocol or protocols is at least partly dependent on the hardware equipment used in system 800.

As illustrated, rack 810 includes N blades 820. In one embodiment, in addition to rack 810, system 800 includes rack 850. As illustrated, rack 850 includes M blades 860. M is not necessarily the same as N; thus, it will be understood that various different hardware equipment components could be used, and coupled together into system 800 over fabric 870. Blades 860 can be the same or similar to blades 820. Nodes 830 can be any type of node as described herein, and are not necessarily all the same type of node. System 800 is not limited to being homogenous, nor is it limited to not being homogenous.

For simplicity, only the node in blade 820[0] is illustrated in detail. However, other nodes in system 800 can be the same or similar. At least some nodes 830 are computation nodes, with processor 832 and memory 840. A computation node refers to a node with processing resources (e.g., one or more processors) that executes an operating system and can receive and process one or more tasks. In one embodiment, at least some nodes 830 are storage server nodes with a server as processing resources 832 and memory 840. A storage server refers to a node with more storage resources than a computation node, and rather than having processors for the execution of tasks, a storage server includes processing resources to manage access to the storage nodes within the storage server.

In one embodiment, node 830 includes interface controller 834, which represents logic to control access by node 830 to fabric 870. The logic can include hardware resources to interconnect to the physical interconnection hardware. The logic can include software or firmware logic to manage the interconnection. In one embodiment, interface controller 834 is or includes a host fabric interface (HFI). Node 830 includes memory subsystem 840, which provides storage services for data to be computed by processors 832. Processor 832 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory 840 can be or include memory devices and a memory controller.

Reference to memory devices can apply to different memory types. Memory devices generally refer to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR3 (dual data rate version 3, original release by JEDEC (Joint Electronic Device Engineering Council) on Jun. 27, 2007, currently on release 21), DDR4 (DDR version 4, initial specification published in September 2012 by JEDEC), DDR4E (DDR version 4, extended, currently in discussion by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (currently in discussion by JEDEC), HBM2 (HBM version 2), currently in discussion by JEDEC), or others or combinations of memory technologies, and technologies based on derivatives or extensions of such specifications.

In addition to, or alternatively to, volatile memory, in one embodiment, reference to memory devices can refer to a nonvolatile memory device whose state is determinate even if power is interrupted to the device. In one embodiment, the nonvolatile memory device is a block addressable memory device, such as NAND or NOR technologies. Thus, a memory device can also include a future generation nonvolatile devices, such as a three dimensional crosspoint (3DXP) memory device, other byte addressable nonvolatile memory devices, or memory devices that use chalcogenide phase change material (e.g., chalcogenide glass). In one embodiment, the memory device can be or include multi-threshold level NAND flash memory, NOR flash memory, single or multi-level phase change memory (PCM) or phase change memory with a switch (PCMS), a resistive memory, nanowire memory, ferroelectric transistor random access memory (FeTRAM), magnetoresistive random access memory (MRAM) memory that incorporates memristor technology, or spin transfer torque (STT)-MRAM, or a combination of any of the above, or other memory.

In one embodiment, node 830 includes network analytics 880, which can include data analytics processing for a network of data collection nodes or sensors in accordance with any embodiment described herein. Network analytics 880 can be or include a network manager to execute an analytics directed data collection system in accordance with any embodiment described herein. Network analytics 880 can determine what data to collect, and when, and at what level of granularity. Network analytics 880 provides direction to a network of data nodes to dynamically adjust data collection operation in accordance with data analytics, in accordance with any embodiment described herein.

In one aspect, a data collection system includes: a network of data nodes distributed over a data collection area, to sample data for the data collection area; and a network manager to couple to the network of data nodes, the network manager to determine a data collection strategy for the data collection area, and dynamically provide direction to the data nodes in accordance with the data collection strategy, the direction to cause one or more data nodes to dynamically change an amount of data to communicate to the network manager.

In one embodiment, the data collection area comprises a geographic area. In one embodiment, the data collection area comprises a physical system. In one embodiment, the data nodes comprise sensor nodes. In one embodiment, the network manager to determine the strategy comprises the network manager to determine a cost of communication for the data nodes. In one embodiment, the network manager to determine the strategy comprises the network manager to determine that two of the data nodes collect substantially similar data; and direct one of the two data nodes to not communicate the substantially similar data. In one embodiment, the network manager to provide direction to the data nodes comprises the network manager to cause selected data nodes to communicate more data to the network manager. In one embodiment, the network manager to provide direction to the data nodes comprises the network manager to cause selected data nodes to communicate less data to the network manager. In one embodiment, the network manager to provide direction to the data nodes comprises the network manager to cause selected data nodes to communicate no data to the network manager. In one embodiment, the network manager to provide direction to the data nodes comprises the network manager to cause selected data nodes to adjust a data sampling frequency to generate fewer data samples. In one embodiment, the network manager to provide direction to the data nodes comprises the network manager to cause selected data nodes to adjust a data sampling frequency to generate more data samples. In one embodiment, the network manager to provide direction to the data nodes comprises the network manager to cause selected data nodes to store generated data and communicate less data to the network manager. In one embodiment, the network manager to provide direction to the data nodes comprises the network manager to cause selected data nodes to store generated data for later communication, which is not initially communicated to the network manager. In one embodiment, the network manager to provide direction to the data nodes comprises the network manager to cause selected data nodes to adjust a data sampling resolution. In one embodiment, the network manager to provide direction to the data nodes comprises the network manager to cause data nodes to dynamically change an amount of data to communicate based at least in part on a location of the data node in the data collection area. In one embodiment, the network manager to provide direction to the data nodes comprises the network manager to cause data nodes to dynamically change an amount of data to communicate based at least in part on a type of sensor included in the data node. In one embodiment, further comprising the data nodes to perform edge compression on the data.

In one aspect, a method for data collection in a network of nodes includes: receiving data from a network of data nodes distributed over a data collection area; determining from the data a data collection strategy for the data collection area; and providing direction to the data nodes in accordance with the data collection strategy, the direction to cause one or more data nodes to dynamically change an amount of data to communicate to the network manager.

In one embodiment, the data collection area comprises a geographic area. In one embodiment, the data collection area comprises a physical system. In one embodiment, the data nodes comprise sensor nodes. In one embodiment, determining the strategy comprises determining a cost of communication for the data nodes. In one embodiment, determining the strategy comprises: determining that two of the data nodes are collecting substantially similar data; and directing one of the two data nodes to not communicate the substantially similar data. In one embodiment, providing direction to the data nodes comprises providing instructions to cause selected data nodes to communicate more data to the network manager. In one embodiment, providing direction to the data nodes comprises providing instructions to cause selected data nodes to communicate less data to the network manager. In one embodiment, providing direction to the data nodes comprises providing instructions to cause selected data nodes configured to not communicate data to the network manager to begin to communicate data to the network manager. In one embodiment, providing direction to the data nodes comprises providing instructions to cause selected data nodes configured to communicate data to the network manager to stop communicating data to the network manager. In one embodiment, providing direction to the data nodes comprises providing instructions to cause selected data nodes to adjust a data sampling frequency. In one embodiment, adjusting the data sampling frequency comprises generating fewer data samples. In one embodiment, adjusting the data sampling frequency comprises generating more data samples. In one embodiment, providing direction to the data nodes comprises providing instructions to cause selected data nodes to store more data and communicate less data to the network manager. In one embodiment, providing direction to the data nodes comprises providing instructions to cause selected data nodes to adjust a data sampling resolution. In one embodiment, providing direction to the data nodes comprises providing instructions to cause selected data nodes to store generated data for later communication, which is not initially communicated to the network manager. In one embodiment, providing direction to the data nodes comprises providing instructions to cause selected data nodes to cause data nodes to dynamically change an amount of data to communicate based at least in part on a location of the data node in the data collection area. In one embodiment, providing direction to the data nodes comprises providing instructions to cause selected data nodes to cause data nodes to dynamically change an amount of data to communicate based at least in part on a type of sensor included in the data node. In one embodiment, further comprising the data nodes to perform edge compression on the data.

In one aspect, an apparatus comprising means for performing operations to execute a method in accordance with any embodiment of the above method for data collection in a network of nodes. In one aspect, an article of manufacture comprising a computer readable storage medium having content stored thereon, which when accessed causes a device to perform operations to execute a method in accordance with any embodiment of the above method for data collection in a network of nodes.

In one aspect, a data node of a network of nodes includes: a sensor to sample data for a data collection area; and logic to receive direction from a network manager and dynamically change an amount of data to communicate to the network manager in response to the direction, wherein the network manager is to determine a data collection strategy for the data collection area, and provide the direction in accordance with the data collection strategy. In one embodiment, the data collection area comprises a geographic area. In one embodiment, the data collection area comprises a physical system. In one embodiment, the data node comprises multiple different sensors. In one embodiment, the network manager is to determine the strategy based at least in part on a cost of communication for the data nodes. In one embodiment, the network manager to determine the strategy comprises the network manager to determine that two of the data nodes collect substantially similar data; and direct one of the two data nodes to not communicate the substantially similar data. In one embodiment, the logic to change the amount of data to communicate comprises the logic to communicate more data to the network manager. In one embodiment, the logic to change the amount of data to communicate comprises the logic to communicate less data to the network manager. In one embodiment, the logic to change the amount of data to communicate comprises the logic to adjust a data sampling frequency to generate fewer data samples. In one embodiment, the logic to change the amount of data to communicate comprises the logic to adjust a data sampling frequency to generate more data samples. In one embodiment, the logic to change the amount of data to communicate comprises the logic to store generated data and communicate less data to the network manager. In one embodiment, the logic to change the amount of data to communicate comprises the logic store generated data for later communication, which is not initially communicated to the network manager. In one embodiment, the logic to change the amount of data to communicate comprises the logic to adjust a data sampling resolution. In one embodiment, the logic to change the amount of data to communicate comprises the logic to dynamically change an amount of data to communicate based at least in part on a location of the data node in the data collection area. In one embodiment, the logic to change the amount of data to communicate comprises the logic to dynamically change an amount of data to communicate based at least in part on a type of sensor included in the data node. In one embodiment, further comprising compression logic to perform edge compression on the data.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware, software, or a combination. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, data, or a combination. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters or sending signals, or both, to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A data collection system, comprising:
a network of data nodes distributed over a data collection area, to sample data for the data collection area; and
a network manager to couple to the network of data nodes, the network manager to determine a data collection strategy for the data collection area, and dynamically provide direction to the data nodes in accordance with the data collection strategy, the direction to cause one or more data nodes to dynamically change an amount of data to communicate to the network manager.

2. The data collection system of claim 1, wherein the data collection area comprises a geographic area.

3. The data collection system of claim 1, wherein the data collection area comprises a physical system.

4. The data collection system of claim 1, wherein the data nodes comprise sensor nodes.

5. The data collection system of claim 1, wherein the network manager to determine the strategy comprises the network manager to determine a cost of communication for the data nodes.

6. The data collection system of claim 1, wherein the network manager to determine the strategy comprises the network manager to
determine that two of the data nodes collect substantially similar data; and
direct one of the two data nodes to not communicate the substantially similar data.

7. The data collection system of claim 1, wherein the network manager to provide direction to the data nodes comprises the network manager to cause selected data nodes to communicate more data to the network manager.

8. The data collection system of claim 1, wherein the network manager to provide direction to the data nodes comprises the network manager to cause selected data nodes to communicate less data to the network manager.

9. The data collection system of claim 1, wherein the network manager to provide direction to the data nodes comprises the network manager to cause selected data nodes to adjust a data sampling frequency to generate fewer data samples.

10. The data collection system of claim 1, wherein the network manager to provide direction to the data nodes comprises the network manager to cause selected data nodes to adjust a data sampling frequency to generate more data samples.

11. The data collection system of claim 1, wherein the network manager to provide direction to the data nodes comprises the network manager to cause selected data nodes to store generated data and communicate less data to the network manager.

12. The data collection system of claim 1, wherein the network manager to provide direction to the data nodes comprises the network manager to cause selected data nodes to store generated data for later communication, which is not communicated to the network manager.

13. The data collection system of claim 1, wherein the network manager to provide direction to the data nodes comprises the network manager to cause selected data nodes to adjust a data sampling resolution.

14. The data collection system of claim 1, wherein the network manager to provide direction to the data nodes comprises the network manager to cause data nodes to dynamically change an amount of data to communicate based at least in part on a location of the data node in the data collection area.

15. The data collection system of claim 1, wherein the network manager to provide direction to the data nodes comprises the network manager to cause data nodes to dynamically change an amount of data to communicate based at least in part on a type of sensor included in the data node.

16. The data collection system of claim 1, further comprising the data nodes to perform edge compression on the data.

17. A method for data collection in a network of nodes, comprising:
receiving data from a network of data nodes distributed over a data collection area;
determining from the data a data collection strategy for the data collection area; and
providing direction to the data nodes in accordance with the data collection strategy, the direction to cause one or more data nodes to dynamically change an amount of data to communicate to the network manager.

18. The method of claim 17, wherein the data collection area comprises a geographic area or a physical system.

19. The method of claim 17, wherein determining the strategy comprises determining a cost of communication for the data nodes.

20. The method of claim 17, wherein determining the strategy comprises:
determining that two of the data nodes are collecting substantially similar data; and
directing one of the two data nodes to not communicate the substantially similar data.

21. The method of claim 17, wherein providing direction to the data nodes comprises providing instructions to cause selected data nodes to communicate more or less data to the network manager.

22. The method of claim 17, wherein providing direction to the data nodes comprises providing instructions to cause selected data nodes to adjust a data sampling frequency.

23. The method of claim 17, wherein providing direction to the data nodes comprises providing instructions to cause selected data nodes to store more data and communicate less data to the network manager.

24. The method of claim 17, wherein providing direction to the data nodes comprises providing instructions to cause selected data nodes to adjust a data sampling resolution.

25. The method of claim 17, wherein providing direction to the data nodes comprises providing instructions to cause selected data nodes to cause data nodes to dynamically change an amount of data to communicate based at least in part on a location of the data node in the data collection area.

26. The method of claim 17, wherein providing direction to the data nodes comprises providing instructions to cause selected data nodes to cause data nodes to dynamically change an amount of data to communicate based at least in part on a type of sensor included in the data node.
